(19) United States
(12) Patent Application Publication
(10) Pub. No.: US 2010/0028674 A1
(43) Pub. Date: Feb. 4, 2010

(54) Nanofibers And Methods For Making The Same

(76) Inventor: Fredrick O Ochanda, Painted Post, NY (US)

Correspondence Address: CORNING INCORPORATED, SP-TI-3-1, CORNING, NY, 14831, US

(21) Appl. No.: 12/183,464

(22) Filed: Jul. 31, 2008

(51) Int. Cl. B32B 5/18; B29C 67/00; B32B 5/16; C01B 13/14; C01G 25/02; C01G 49/02; C01F 7/02

(52) U.S. Cl. 428/376; 264/465; 264/466; 428/401; 423/592.1; 423/608; 423/632; 423/625; 423/594.1; 977/810

(57) ABSTRACT

Nanofibers and methods for making the nanofibers are described. Porous metal oxide nanofibers and porous metal oxide nanofibers comprising metal nanoparticles made via electrospinning methods are also described.

### BACKGROUND

1. Field

Embodiments of the invention relate to nanofibers and methods for making the nanofibers.

2. Technical Background

Electrospinning can provide a simple and versatile method for fabricating fibers from a variety of materials including polymers, composites and ceramics. Electrospinning has been used to fabricate polymer fibers from solution. Electrospinning is similar to conventional processes for drawing microscale fibers except for the use of electrostatic repulsions between surface charges as opposed to a mechanical or shear force to continually reduce the diameter of a viscoelastic jet or a glassy filament. Fibers generated from electrospinning can be thinner in diameter than those generated from mechanical drawing, since increased elongation can be achieved through the application of an external electric field.

Interest in electrospinning has grown over the years due, in part, to the capability of electrospinning a wide range of polymeric and inorganic materials. Interest in electrospinning ranges, for example, from the electrospinning process, to filtration media, to adsorption layers in protective clothing, and to electronics.

Nanofibers and nanotubes have attracted interest for the potential application as supports, for example, catalyst supports, since nanofibers and nanotubes have large surface areas, despite being small structures, and unique metal/support interactions, offering catalytic behavior distinct from traditional supports such as activated charcoal.

Among the metallic elements, gold is considered the most inert, but can show catalytic activity when its particle size is in the nanometer range. Different substrates have been used as supports for gold catalysts, such as ZrO₂, Al₂O₃, Zeolite molecular sieves, TiO₂, etc, using different synthetic routes (sol-gel, deposition/precipitation, electroless deposition). Despite this, the use of gold nanoparticles in catalysis is still not fully explored, especially the preparation of highly monodispersed gold catalysts.

Conventional methods for making metal nanoparticle containing nanofibers generally involve incorporation of already prepared nanoparticles through processes such as wetness impregnation.

It would be advantageous to have a method for making nanofibers comprising one or more metal oxides utilizing electrospinning. It would also be advantageous to have the resulting nanofibers be porous. Further, it would be advantageous to have porous metal oxide nanofibers comprising metal nanoparticles in the pores made via electrospinning. Also, it would be advantageous if the metal nanoparticles in the pores of the nanofiber were catalytic.

### SUMMARY

One embodiment of the invention is a method for making a nanofiber. The method comprises providing a solution comprising a metal oxide precursor and a solvent, providing an emulsion comprising a metal nanoparticle precursor, combining the solution, the emulsion, a reducing agent, and a co-solvent to form a mixture comprising metal nanoparticles, thermally inducing phase separation of the mixture, and forming the nanofiber from the phase separated mixture.

Another embodiment is a nanofiber comprising a metal oxide support comprising pores and comprising metal nanoparticles dispersed within the pores.

Yet another embodiment is a method for making a nanofiber. The method comprises providing a solution comprising a solvent, a zirconium oxide precursor and an iron (III) oxide precursor, combining the solution with a co-solvent to form a mixture, thermally inducing phase separation of the mixture, and forming a zirconium oxide stabilized iron (III) oxide nanofiber from the phase separated mixture.

Another embodiment is a zirconium oxide stabilized iron (III) oxide nanofiber.

The nanofibers and methods for making the nanofibers according to the invention provide one or more of the following advantages: ability to synthesize porous metal oxide nanofibers; synthesize nanofibers having a high surface area and aspect ratio; incorporate metal nanoparticles into the porous metal oxide nanofibers; disperse metal nanoparticles on the porous metal oxide nanofibers, wherein nanoparticle migration and agglomeration are reduced as compared to conventional methods; and produce monodispersed nanoparticles along the porous nanofibers.

Additional features and advantages of the invention will be set forth in the detailed description which follows, and in part will be readily apparent to those skilled in the art from the description or recognized by practicing the invention as described in the written description and claims hereof, as well as the appended drawings.

It is to be understood that both the foregoing general description and the following detailed description are merely exemplary of the invention, and are intended to provide an overview or framework for understanding the nature and character of the invention as it is claimed.

The accompanying drawings are included to provide a further understanding of the invention, and are incorporated in and constitute a part of this specification. The drawings illustrate one or more embodiment(s) of the invention and together with the description serve to explain the principles and operation of the invention.

### BRIEF DESCRIPTION OF THE DRAWINGS

The invention can be understood from the following detailed description either alone or together with the accompanying drawing figures.

FIG. 1 is a scanning electron microscope (SEM) micrograph of nanofibers, according to one embodiment.

FIG. 2 is a transmission electron microscope (TEM) micrograph of nanofibers, according to one embodiment.

FIG. 3 is a transmission electron microscope (TEM) micrograph of nanofibers, according to one embodiment.

### DETAILED DESCRIPTION

Reference will now be made in detail to various embodiments of the invention. Wherever possible, the same reference numbers will be used throughout the drawings to refer to the same or like features.

One embodiment of the invention is a method for making a nanofiber. The method comprises providing a solution comprising a metal oxide precursor and a solvent, providing an emulsion comprising a metal nanoparticle precursor, combining the solution, the emulsion, a reducing agent, and a co-solvent to form a mixture comprising metal nanoparticles, thermally inducing phase separation of the mixture, and forming the nanofiber from the phase separated mixture.

The solvent, in some embodiments, has a high dielectric constant and can be selected from formic acid, dimethyl-N′N′-formamide (DMF), dimethyl sulfoxide, methanol, acetonitrile, nitric acid, nitrobenzene, acetone, ethanol, acetyl acetone, methyl acetate, dimethyl sulfate, chloroacetone, water, and combinations thereof.

The co-solvent, in some embodiments, has a high vapor pressure and can be selected from chloroform, tetrahydrofuran (THF), acetonitrile, nitric acid, methylene chloride, methanol, pentane, hexane, cyclohexane, and combinations thereof.

The solution can further comprise a polymer and a surfactant. The emulsion can further comprise a surfactant, an organic phase, and an aqueous phase. The emulsion can be a microemulsion, in some embodiments. The organic phase, in some embodiments, comprises cyclohexane, hexane, tetrahydrofuran, mineral oil, motor oil, toluene, pentane, chloroform, methylene chloride, heptane, silicone oil, or combinations thereof.

Exemplary surfactants for both the solution and the emulsion are Dow™ fax 2A1, cetyl trimethyl ammonium bromide (CTAB), Pluronic™ 123, Tergitol™ TMN 10, Brij™ 98, Dioctyl sulfosuccinate sodium salt, Triton™ X-100, Span™ 80 and Tween™ 20.

Emulsions, for example, microemulsions formed via reverse micelle synthesis facilitate metal ions coming in contact with a reducing agent to form metal nanoparticles. These water-in-oil emulsions are thermodynamically stable mixtures of nano-sized aqueous droplets surrounded by a monolayer of surfactant molecules dispersed in a continuous non-polar organic medium. The nanoparticles do not readily aggregate in the microemulsion core because of like charges on the droplet based on ionic surfactant and also due to the stabilizing power of the PVP polymer in the sol-gel solution. This provides an optimum microenvironment for making monodispersed nanoparticles.

The polymers which have bonding functional groups can be selected to bond with the metal ions or the metal nanoparticles in the emulsion. Suitable functional groups for bonding to the metal ions or metal nanoparticles include one or more of a hydroxyl, a carboxyl, carbonyl, an amine, an amide, an amino acid, a thiol, a sulfonic acid, a sulfonyl halide, an acyl halide, a nitrile, nitrogen with a free lone pair of electrons (e.g., pyridine), or combinations thereof, or derivatives thereof. Examples of such polymers other than PVP which can also be used, according to some embodiments, include polyacrylic acid (PAA), polyvinyl alcohol (PVA), Poly (vinyl-2-pyridine) and poly (vinyl-4-pyridine).

The size of the aqueous droplets in water-in-oil microemulsions can be controlled by the water-to-surfactant ratio and nature of the continuous medium. Transitioning from a basic medium to an acidic medium can result in the reduction of the nanodroplet size. The droplet size can be reduced further, for example, during the stretching and whipping of the jet as electrospinning is performed. The voids created via the droplets during electrospinning, and the continuous porosity of the fibers ensures that the metal nanoparticles, for example, gold nanoparticles are monodispersed along the length of the nanofibers. This would facilitate contact between the gold nanoparticles, which can act as catalysts, and a CO gas stream and hence facilitating the oxidation process.

Metal oxide precursors, for instance, iron oxide precursors, according to some embodiments comprise iron (III) acetyl acetonate, lower straight or branched chain alkoxides of iron having from 1 to 8 carbon atoms, for example, ethoxides, propoxides, butoxides, or combinations thereof. Metal oxide precursors, for instance, zirconium oxide precursors, according to some embodiments, comprise primary, secondary, tertiary alkoxides, or combinations thereof. Secondary and tertiary alkoxides, for example, zirconium (IV) isopropoxide, tert butoxide, methoxide or ethoxide have the advantage of increased solubility in organic solvents.

Metal nanoparticle precursors, according to some embodiments, comprise gold precursors, platinum precursors, copper precursors, palladium precursors, nickel precursors, or combinations thereof. Gold precursors can be chlorauric acid (HAuCl₄), potassium tetrachloroaurate(III) (KAuCl₄), sodium gold (I) thiosulphate, gold (I)-glutathione polymers, dimethylacetylacetonato gold (III), gold (I) thiolate complexes, chloro (triphenyl phosphine) gold (I), or combinations thereof.

Phase separation can be accomplished by cooling the mixture at temperatures of from −25° C. to 0° C., for example, from −20° C. to −5° C., for example, from −15° C. to −10° C. The cooler temperatures can induce phase separation by reducing the dissolving power of the solvent and/or co-solvent such that one or more of the components of the solution, the emulsion, and/or the mixture separate from the solvent and/or the co-solvent. Upon phase separation, the mixture can become visibly cloudy.

Forming the nanofiber from the phase separated mixture, according to some embodiments, comprises electrospinning. Electrospinning uses the application of an electrostatic field to a capillary connected to a reservoir containing the phase separated mixture. Under the influence of the electrostatic field, a pendant droplet of the solution or melt at the capillary tip is deformed into a conical shape, for instance, a Taylor cone.

If the voltage surpasses a threshold value, electrostatic forces overcome the surface tension, and a fine charged jet is ejected. The jet moves rapidly through the air towards a counter electrode. Owing to its high viscosity and interpolymer interactions, the jet remains stable and does not transform into spherical droplets as expected for a liquid cylindrical thread. As the jet travels in the air, the solvent evaporates, leaving behind a charged nanofiber which can be deposited on a collector located at the counter electrode. More than one nanofiber can be formed. Thus, one continuous nanofiber or nanofibers can be deposited to form a non-woven fabric. Electrospinning, according to some embodiments, comprises depositing the nanofiber on a charged collector. The collector can be a floating collector.

In the electrospinning process, the operating parameters can be varied, for instance, the pump rate can be from 0.06 to 0.50 mL/hr; the solution temperature can be from 0° C. to −30° C.; the applied voltage (to the phase separated mixture and/or the collector) can have a positive polarity of from 5.0 kV to 15 kV and/or a negative polarity of from 1.0 kV to 10.0 kV; the spinneret to floating collector separation can be adjusted 1.0 cm/kV; the humidity can be from 20% to 60%; and the internal diameter of the nozzle or spinneret can be from 150 μm to 508 μm, for example, from 30 to 21 gauge.

In one embodiment, the method further comprises calcining the nanofiber after forming the nanofiber from the phase separated mixture to convert the metal oxide precursor to a metal oxide. Calcining temperatures can be adjusted depending on the organics used. In some embodiments, the organics degrade around 500° C. In other embodiments, the organics degrade around 550° C.

The nanofiber, in one embodiment, comprises pores and has metal nanoparticles dispersed in one or more of the pores.

In some embodiments, the method further comprises adding a reducing agent to the emulsion or to a combination of the solution and the emulsion before combining the solution, the emulsion, and the co-solvent to form a mixture. In some embodiments, the reducing agent comprises sodium citrate, sodium borohydride, urea, diborane (B₂H₆), sodium cyanoborohydride, or combinations thereof.

Another embodiment is a nanofiber comprising a metal oxide support comprising pores and comprising metal nanoparticles dispersed within the pores.

The nanofiber, in some embodiments, has a diameter of 300 nanometers (nm) or less, for example, 200 nm or less, for example, 150 nm or less. In some embodiments, the nanofiber has a diameter of from 10 nm to 300 nm, for example, from 40 nm to 300 nm, for example, from 40 nm to 150 nm. The diameter of the nanofiber can vary along its length or the diameter can remain constant.

The metal oxide support, in some embodiments, comprises zirconium oxide, aluminum oxide, iron (III) oxide, or combinations thereof, for example, the nanofiber can comprise zirconium oxide stabilized iron (III) oxide.

In some embodiments, the metal nanoparticles are selected from gold, platinum, copper, palladium, nickel, and combinations thereof. The metal nanoparticles can be catalytically active.

Another embodiment is a zirconium oxide stabilized iron (III) oxide nanofiber. The nanofiber, in some embodiments can be formed via an electrospinning process.

The nanofiber, in some embodiments, has a diameter of 300 nanometers (nm) or less, for example, 200 nm or less, for example, 150 nm or less. In some embodiments, the nanofiber has a diameter of from 10 nm to 300 nm, for example, from 40 nm to 300 nm, for example, from 40 nm to 150 nm. The diameter of the nanofiber can vary along its length or the diameter can remain constant.

Porosity, for example, mesoporosity of the nanofiber can be controlled by adjusting parameters such as temperature during the thermally induced phase separation, by selection of the solvent, the co-solvent, the surfactant and the acid or base synthesis. The nanofiber size can be controlled by using a solvent with a high dielectric constant and high electrical conductivity. Component selection along with adjusting the relative amounts of the components of the solution can affect fiber morphology, for example, fiber size, external porosity, and/or internal porosity.

Yet another embodiment is a method for making a nanofiber. The method comprises providing a solution comprising a solvent, a zirconium oxide precursor and an iron (III) oxide precursor, combining the solution with a co-solvent to form a mixture, thermally inducing phase separation of the mixture, and forming a zirconium oxide stabilized iron (III) oxide nanofiber from the phase separated mixture.

### Example 1

400 mg of iron (III) acetyl acetone was weighed into a vial containing 6.5 mL of DMF. To this, 2 weight % zirconium (IV) propoxide (65 mg, based on weight of iron salt) was added followed by addition of 100 mg of Pluronic™ 123. Finally, 1200 mg of PVP was measured and added. The components were stirred until they were dissolved (about 2 hours of stirring). To this solution, 1.5 mL of THF, a co-solvent, was measured and added followed by stirring for another 1.0 hour to form a mixture. The mixture was placed into a freezer which was set at −15° C. for 12 hours to thermally induce phase separation, after which electrospinning was performed.

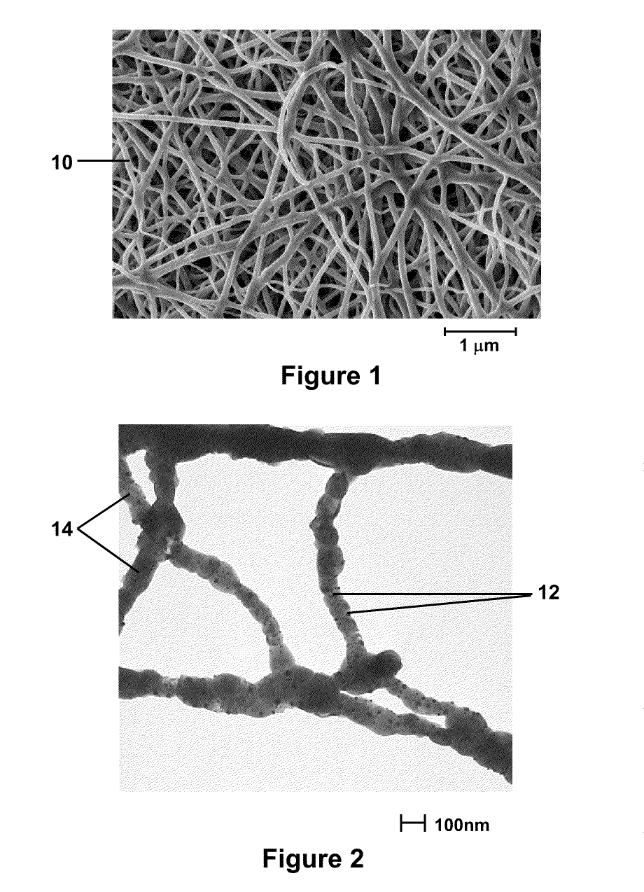

The electrospinning parameters were as follows: the distance from the nozzle to the collector was 15.0 cm; the applied voltage was 10.0 kV (positive) and 5.0 kV (negative) (the phase separated mixture was charged positively and the collector was at a negative voltage); the pump rate was 0.2 mL/hr; the humidity was 22%; the temperature was 26° C.; and the needle size of the nozzle was 25.0 gauge. Calcining (heat treatment) of the nanofibers was performed starting at room temperature and ramped to 500° C. in air at a rate of 10° C./minute. The temperature was held at 500° C. for 2.0 hours before cooling to 50° C. at a rate of 10° C./minute. The resulting nanofibers were analyzed using an SEM. Zirconia stabilized iron (III) oxide nanofibers 10, according to one embodiment of the invention and made according to the method described in example 1, are shown in FIG. 1.

The solvent having a high dielectric constant, in this example, DMF and a co-solvent having a high vapor pressure, in this example, THF were used. High dielectric constant solvents stabilize ionic charges (suppress ion aggregation) in the metal oxide precursor solution and also enhance stretching of the jet resulting in fibers with small diameter. The average diameters of the nanofibers, in this example, were from 40 nm to 140 nm.

Table 1 shows N₂ Desorption/Adsorption Surface area measurements of the zirconia stabilized iron (III) oxide nanofibers. The corresponding porosimetry analysis show that the zirconia stabilized iron (III) oxide nanofibers are porous with BJH Desorption Cumulative surface area of 109.5 m²/g and a pore diameter of 128.8 Å.

TABLE 1

| | | | BJH Desorption | |
|---|---|---|---|---|
| Multiple | | BJH Desorption | Cumulative | BJH Desorption |
| Point BET | Single Point | Cumulative | Pore Volume | Pore Diameter |
| (m²/g) | BET (m²/g) | SA (m²/g) | (cc/g) | (Mode) (Å) |
| 88.01 | 86.41 | 109.5 | 0.3525 | 128.8 |

### Example 2

400 mg of iron (III) acetyl acetone was weighed into a vial containing 6.5 mL of DMF. To this, 2 weight % zirconium (IV) propoxide (65 mg, based on weight of iron salt) was added followed by addition of 100 mg of Pluronic™ 123. Finally, 1200 mg of PVP was measured and added. The components were stirred until the components were dissolved (about 2 hours of stirring) forming a solution.

An emulsion comprising gold salt was prepared as follows: a microemulsion was made with H₂O: Cyclohexane: AOT (Dioctyl sulfosuccinate, Sodium salt) in the ratio of 10:60:30 by weight, respectively and 20 mg HAuCl was added followed by stirring at 1150 rpm.

The resulting emulsion was mixed with the solution and further stirred to homogeneity. The gold ions in the emulsion were reduced by the addition of 0.1 mL of 0.1M sodium borohydride solution, a reducing agent. To this, 1.5 ml of THF, a co-solvent, was measured and added followed by stirring for another 1.0 hour to form a mixture. The mixture was placed into a freezer set at −15° C. for 12 hours to thermally induce phase separation, after which electrospinning was performed.

The electrospinning parameters were as follows: the distance from the nozzle to the collector was 15.0 cm; the applied voltage was 10.0 kV (positive) and 5.0 kV (negative); the pump rate was 0.2 mL/hr; the humidity was 20%; the temperature was 27° C.; and the needle size of the nozzle was 25.0 gauge. Calcining (heat treatment) of the nanofibers was performed starting at room temperature and ramped to 500° C. in air at a rate of 10° C./minute. The temperature was held at 500° C. for 2.0 hours before cooling to 50° C. at a rate of 10° C./minute. The resulting nanofibers were analyzed using a TEM.

FIG. 2 shows nanofibers 14, according to one embodiment of the invention and made according to the method described in example 2, comprising a metal oxide support comprising pores and comprising metal nanoparticles 12 dispersed within the pores. In this example, a porous zirconium oxide stabilized iron (III) oxide nanofiber having gold dispersed within the pores is shown.

### Example 3

500 mg of aluminum tri-sec-butoxide was weighed into a vial containing 6.5 mL of Formic acid. To this, 100 mg of Pluronic™ 123 was added. Finally, 1200 mg of PVP was measured and added. The components were stirred until the components were dissolved (about 2 hours stirring).

An emulsion comprising gold salt was prepared as follows: a microemulsion was made with H₂O: Cyclohexane: AOT (Dioctyl sulfosuccinate, Sodium salt) in the ratio of 10:60:30 by weight, respectively and 20 mg HAuCl was added followed by stirring at 1150 rpm.

The resulting emulsion was mixed with the solution and further stirred to homogeneity. The gold ions in the emulsion were reduced by the addition of 0.1 mL of 0.1M sodium borohydride solution, a reducing agent. To this, 1.5 ml of THF was measured and added followed by stirring for another 1.0 hour to form a mixture. The mixture was placed into a freezer set at −15° C. for 12 hours after which electrospinning was performed.

The electrospinning parameters were as follows: the distance from the nozzle to the collector was 15.0 cm; the applied voltage was 10.0 kV (positive) and 5.0 kV (negative); the pump rate was 0.2 mL/hr; the humidity was 24%; the temperature was 26.8° C.; and the needle size of the nozzle was 25.0 gauge. Calcining (heat treatment) of the nanofibers was performed starting at room temperature and ramped to 500° C. in air at a rate of 10° C./minute. The temperature was held at 500° C. for 2.0 hours before cooling to 50° C. at a rate of 10° C./minute. The resulting nanofibers were analyzed using a TEM.

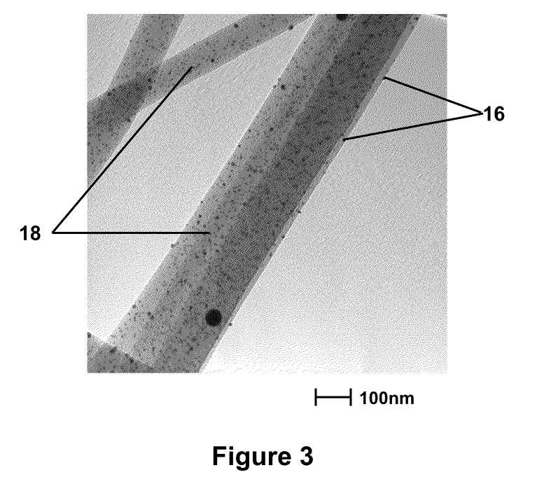

FIG. 3 shows nanofibers 18, according to one embodiment of the invention and made according to the method described in example 3, comprising a metal oxide support comprising pores and comprising metal nanoparticles 16 dispersed within the pores. In this example, gold nanoparticles are uniformly dispersed along aluminum oxide nanofibers with negligible agglomeration.

It will be apparent to those skilled in the art that various modifications and variations can be made to the present invention without departing from the spirit or scope of the invention. Thus, it is intended that the present invention cover the modifications and variations of this invention provided they come within the scope of the appended claims and their equivalents.

What is claimed is:

1. A method for making a nanofiber, the method comprising:
providing a solution comprising a metal oxide precursor and a solvent;
providing an emulsion comprising a metal nanoparticle precursor;
combining the solution, the emulsion, a reducing agent, and a co-solvent to form a mixture comprising metal nanoparticles;
thermally inducing phase separation of the mixture; and
forming the nanofiber from the phase separated mixture.

2. The method according to claim 1, further comprising calcining the nanofiber after forming the nanofiber to convert the metal oxide precursor to a metal oxide.

3. The method according to claim 1, wherein forming the nanofiber comprises electrospinning.

4. The method according to claim 3, wherein more than one nanofiber is formed.

5. The method according to claim 3, wherein the electrospinning comprises depositing the nanofiber on a charged collector.

6. The method according to claim 5, wherein the collector is a floating collector.

7. The method according to claim 1, wherein the nanofiber comprises pores and has metal nanoparticles dispersed in one or more of the pores.

8. The method according to claim 1, wherein the solvent has a high dielectric constant.

9. The method according to claim 1, wherein the solvent is selected from formic acid, dimethyl-N′N′-formamide, dimethyl sulfoxide, methanol, acetonitrile, nitric acid, nitrobenzene, acetone, ethanol, acetyl acetone, methyl acetate, dimethyl sulfate, chloroacetone, water, and combinations thereof.

10. The method according to claim 1, wherein the co-solvent has a high vapor pressure.

11. The method according to claim 1, wherein the co-solvent is selected from chloroform, tetrahydrofuran, acetonitrile, nitric acid, methylene chloride, methanol, pentane, hexane, cyclohexane, and combinations thereof.

12. The method according to claim 1, wherein the reducing agent is added to the emulsion or to a combination of the solution and the emulsion before combining the solution, the emulsion, and the co-solvent to form a mixture.

13. The method according to claim 1, wherein the solution further comprises a polymer and a surfactant.

14. The method according to claim 1, wherein the emulsion further comprises a surfactant, an organic phase, and an aqueous phase.

15. The method according to claim 14, wherein the emulsion is a microemulsion.

16. A nanofiber comprising a metal oxide support comprising pores and comprising metal nanoparticles dispersed within the pores.

17. The nanofiber according to claim 16, wherein the nanofiber has a diameter of 300 nanometers or less.

18. The nanofiber according to claim 16, wherein the metal oxide support comprises zirconium oxide, aluminum oxide, iron (III) oxide, or combinations thereof.

19. The nanofiber according to claim 18, comprising zirconium oxide stabilized iron (III) oxide.

20. The nanofiber according to claim 16, wherein the metal nanoparticles are selected from gold, platinum, copper, palladium, nickel, and combinations thereof.

21. The nanofiber according to claim 16, wherein the metal nanoparticles are catalytically active.

22. The nanofiber according to claim 16, formed via an electrospinning process.

23. A zirconium oxide stabilized iron (III) oxide nanofiber.

24. The nanofiber according to claim 23, wherein the nanofiber has a diameter of 300 nanometers or less.

25. A method for making a nanofiber comprising:
providing a solution comprising a solvent, a zirconium oxide precursor and an iron (III) oxide precursor;
combining the solution with a co-solvent to form a mixture;
thermally inducing phase separation of the mixture; and
forming a zirconium oxide stabilized iron (III) oxide nanofiber from the phase separated mixture.
